(19) United States
(12) Patent Application Publication
(10) Pub. No.: US 2026/0089119 A1
(43) Pub. Date: Mar. 26, 2026

(54) Latency Tolerance Escalation Detection

(71) Applicant: Apple Inc., Cupertino, CA (US)

(72) Inventors: Matthew R. Johnson, Belmont, CA (US); Daniel U. Becker, San Jose, CA (US); Joel M. Sandgathe, Cupertino, CA (US)

(21) Appl. No.: 19/043,886

(22) Filed: Feb. 3, 2025

Related U.S. Application Data
(60) Provisional application No. 63/698,383, filed on Sep. 24, 2024.

(51) Int. Cl. H04L 47/783; H04L 49/00; H04L 49/253

(52) U.S. Cl. CPC H04L 47/783; H04L 49/254; H04L 49/3081

(57) ABSTRACT

An apparatus includes a communication fabric, a plurality of agent circuits, a performance management circuit (PMC), and a debug circuit. The communication fabric may transfer transactions from source circuits to destination circuits. The agent circuits may issue real-time (RT) transactions in accordance with a current available bandwidth of the communication fabric. The PMC may allocate, based on the current available bandwidth, respective bandwidth usage targets to ones of the agent circuits. The debug circuit may access operational states of the agent circuits. A given one of the agent circuits may also, based on a determination that the respective bandwidth usage target is insufficient for current activity, capture a set of current values from one or more registers in the given agent circuit without affecting a state of the registers. The given agent circuit may then send at least a portion of the set of current values to the debug circuit.

### PRIORITY CLAIM

The present application claims priority to U.S. Provisional Application No. 63/698,383, entitled “Latency Tolerance Escalation Detection,” filed Sep. 24, 2024, the disclosure of which is incorporated by reference herein in its entirety.

### BACKGROUND

### Technical Field

Embodiments described herein are related to computing systems including, for example, systems-on-chip (SOCs). More particularly, embodiments are disclosed relating to techniques for detecting a mismatch between target and observed communication latencies in a computer system.

### Description of the Related Art

A computer system, such as an SOC, may utilize a network fabric interconnect to provide high bandwidth and low latency transport layers between various agent circuits coupled across one or more networks in the system. Such interconnect architectures may be designed to support a given bandwidth for transporting data between each of the various agent circuits, for example, central processing units (CPUs), graphic processing units (GPUs), neural processing engines, memory systems and the like. In some systems, a communication fabric may include each agent circuit being connected to one of several network interfaces which, in turn, may be coupled to the communication fabric. Such a technique may have a high communication latency, multiple protocol conversions, a high-level of data buffering, and a high-level of power consumption.

Different agent circuits may have different latency tolerances, and these tolerances may vary for a given agent circuit based on a current task being performed. For example, during media playback, a display controller and an audio codec may have low latency tolerances for receiving the media data being presented. Delays in receiving the media data may cause issues like glitching/freezing video and/or audio that is unsynchronized to video. Such agent circuits may receive indications, e.g., from a performance management circuit or other management circuit, of a target latency tolerance for avoiding such issues.

### BRIEF DESCRIPTION OF THE DRAWINGS

The following detailed description makes reference to the accompanying drawings, which are now briefly described.

FIG. 1 illustrates a block diagram of an embodiment of a system that includes latency escalation detector circuits and related snapshot circuits.

FIG. 2 shows a block diagram of another embodiment of a system that includes latency escalation detector circuits and related snapshot circuits.

FIG. 3 depicts a block diagram of a third embodiment of a system that includes latency escalation detector circuits and related snapshot circuits.

FIG. 4 illustrates a block diagram of a fourth embodiment of a system that includes latency escalation detector circuits and related snapshot circuits.

FIG. 5 shows a flow diagram of an embodiment of a method for operating latency escalation detector circuits and related snapshot circuits.

FIG. 6 depicts various embodiments of systems that include integrated circuits that utilize the disclosed techniques.

FIG. 7 is a block diagram of an example computer-readable medium, according to some embodiments.

While embodiments described in this disclosure may be susceptible to various modifications and alternative forms, specific embodiments thereof are shown by way of example in the drawings and will herein be described in detail. It should be understood, however, that the drawings and detailed description thereto are not intended to limit the embodiments to the particular form disclosed, but on the contrary, the intention is to cover all modifications, equivalents and alternatives falling within the spirit and scope of the appended claims.

### DETAILED DESCRIPTION OF EMBODIMENTS

As disclosed above, a computer system may include a plurality of agent circuits. As used herein, an “agent” refers to a any suitable circuit block that is capable of initiating (sourcing) or being a destination for communications via a communication fabric. An agent may generally be any circuit (e.g., CPU, GPU, neural processing engine, peripheral, memory controller, etc.) that may source and/or receive transactions on a given network included in a communication fabric of a computer system. A source agent generates (sources) a transaction, and a destination agent receives the transaction. A given agent may be a source agent for some transactions and a destination agent for others. A “memory transaction” or simply “transaction,” as used herein, refers to a request to read, write, or modify a data value of a particular memory location or group of locations.

To address potential issues associated with transaction latency, some computer systems may implement a closed loop latency tolerance (CLLT) system. A CLLT system may help to protect real-time (RT) agents in the SOC from transaction latency issues. A CLLT system may include a central source (e.g., a performance management circuit) that provides an indication of a target latency tolerance (TLTR) for RT agents to achieve in order for memory transactions (e.g., transfer of data for a video frame to be displayed) to take place. For example, for destination RT agents that receive data (e.g., displays) the TLTR may represent a worst-case transaction latency that the RT agent needs to be able to tolerate without experiencing a data underrun. For source RT agents that send data (e.g., cameras), the TLTR may represent a worst-case transaction latency that the RT agent needs to be able to tolerate without experiencing a data overflow. In such a CLLT system, an RT agent may transmit a current latency tolerance (CLTR) indicating how much latency the RT agent can currently tolerate. If the CLTR is less than the TLTR, then activities in the communication fabric and memory system that may cause bandwidth loss for a duration corresponding to the TLTR may be blocked until the CLTR for RT agent has “caught up” to TLTR. The RT agent may support this catch-up effort by, e.g., temporarily utilizing more than its required bandwidth. A CLTR may be determined based on software or firmware being executed by the RT agent. Accordingly, difficult-to-identify problems may occur, such as an RT agent transmitting, based on the software, a CLTR that is lower than the TLTR despite the RT agent actually being able to tolerate higher latencies than the corresponding CLTR indicates. Identifying such problems may be very time consuming and may be error prone to debug.

To address inaccuracies in how CLTR values may be determined by RT agents, circuits and techniques are proposed that include adding a latency escalation detector circuit and a snapshot circuit to RT agents. The latency escalation detector circuit monitors the CLTR provided by the agent and the TLTR provided by the performance management circuit, and identifies situations in which the CLTR is not responding in the expected fashion over time. If the latency escalation detector circuit detects such a situation, it may trigger the snapshot circuit to capture a current state from the RT agent. The snapshot circuit may capture data when a particular latency escalation detector circuit triggers, providing critical clues to the root cause of a mismatch between current and target latencies. In some embodiments, a latency escalation detector circuit may be highly programmable, allowing conditions for triggering to be tuned for a given system and/or current tasks. In addition, different RT agents in a computer system may have latency escalation detector circuits that are programmed differently, based on how their normal behavior may differ from other RT agents. The data captured by a snapshot circuit may vary from agent to agent as desired.

Novel techniques are disclosed herein which may enable increased visibility into at least a portion of mismatch issues between current and target latency tolerances. In an example system that supports the disclosed techniques, a computer system may include a communication fabric for enabling transactions between various agent circuits across the system, limited at a given time by a current available bandwidth. A performance management circuit may be used to determine, based on the current available bandwidth, respective bandwidth usage targets to respective ones of the agent circuits. A given agent circuit may, based on a determination that the respective bandwidth usage target is insufficient for current activity, capture a set of current values from one or more registers and send at least a portion of the set of current values to a debug circuit.

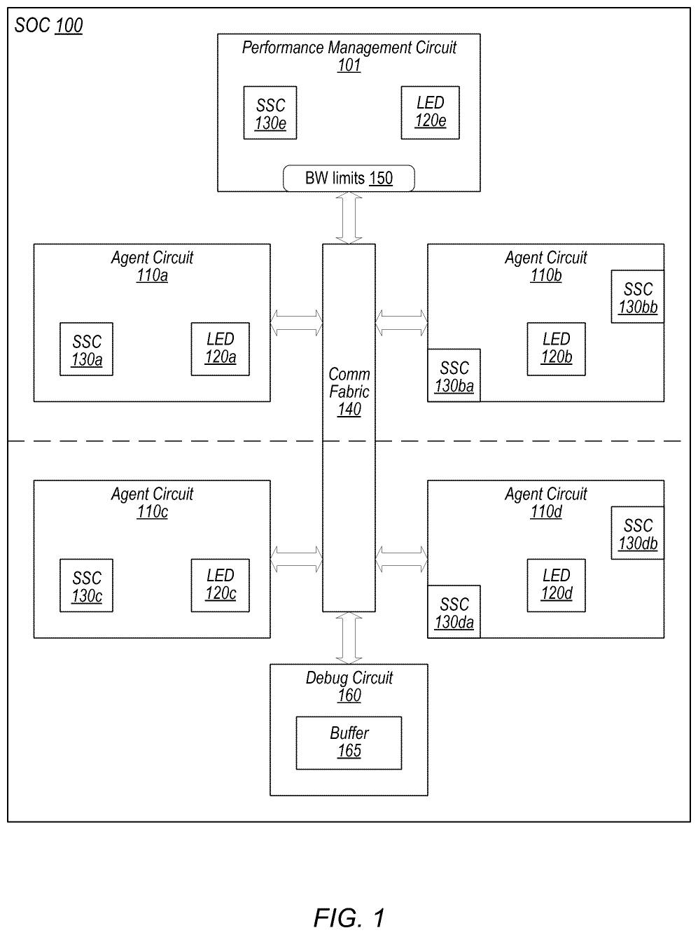

FIG. 1 illustrates a block diagram of an embodiment of a system-on-chip (SOC) that uses latency escalation detector circuits to identify a mismatch between target and current latency tolerances. SOC 100 includes performance management circuit 101, agent circuits 110a-110d (collectively 110), communication fabric 140, and debug circuit 160. Performance management circuit 101 and agent circuits 110 each include a respective one of latency escalation detector (LED) circuits 120a-120e. In addition, each of performance management circuit 101 and agent circuits 110 include one or more snapshot circuits (SSCs) 130a-130e. Agent circuits 110b and 110d each include two SSCs, respectively. Debug circuit 160 includes buffer circuit 165. Performance management circuit 101, agent circuits 110, and debug circuit 160 are coupled to communication fabric 140.

SOC 100 may be included in a computing system, such as a desktop or laptop computer, a smartphone, a tablet computer, a wearable smart device, or the like. In some embodiments, SOC 100 is a single integrated circuit (IC), or a multi-die chip with circuits, such as agent circuits 110, distributed across two or more dies, such as indicated by the dashed line. In some embodiments, SOC 100 is a computer system implemented on co-packaged IC dies. SOC 100 may be configured to operate as a single SOC across the plurality of co-packaged integrated circuit dies. The individual die that comprise a multi-die SOC are referred to herein as “chiplets.” It is to be understood that any SOC disclosed herein can be implemented using a chiplet-based architecture. Accordingly, wherever the term “SOC” appears in this disclosure, those references are intended to also suggest embodiments in which the same functionality is implemented via a less monolithic architecture, such as via multiple chiplets, which may be included in a single package in some embodiments.

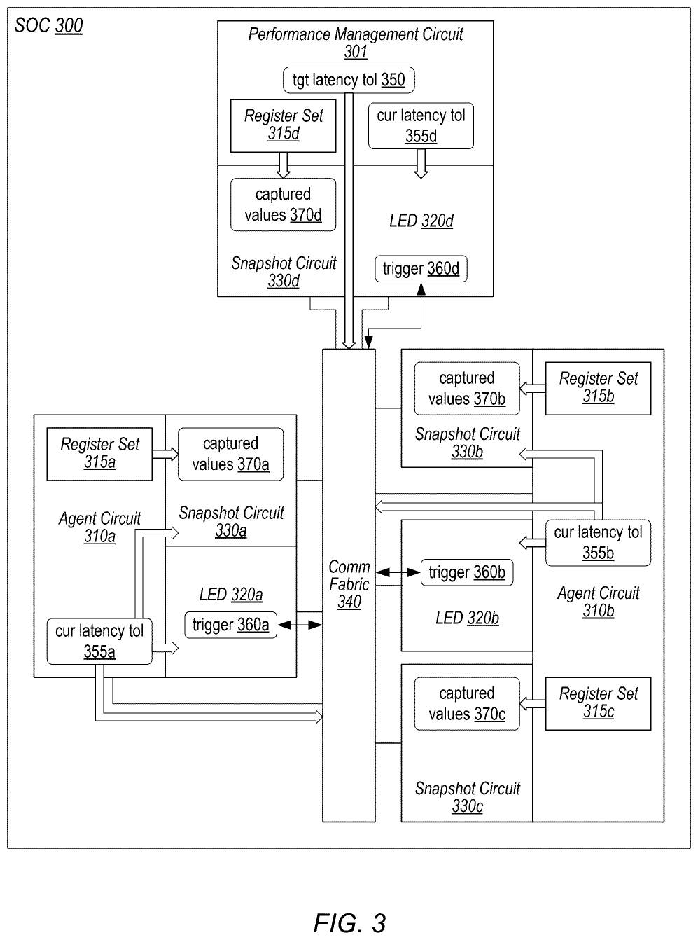

On a related note, such multi-die embodiments are to be understood to encompass both homogeneous designs (in which each SOC includes identical or almost identical functionality) and heterogeneous designs (in which the functionality of each SOC diverges more considerably). Such disclosure also contemplates embodiments in which the functionality of the multiple SOCs is implemented using different levels of discreteness. For example, the functionality of a first system could be implemented on a single IC, while the functionality of a second system (which could be the same or different than the first system) could be implemented using a number of co-packaged chiplets. An example of a multi-die embodiment is illustrated in FIG. 3.

As illustrated, communication fabric 140 is configured to transfer transactions from source agents to destination agents, such as from agent circuit 110a to agent circuit 110d. Although illustrated as a single block, communication fabric 140 may comprise a plurality of different networks coupling agent circuits 110 as well as other circuit blocks that are not illustrated for clarity. For example, communication fabric 140 may include a first network for coupling a plurality of processor cores to one another, a second network for coupling memory circuits to processor cores and other circuits, and a third network for coupling various peripheral circuits (e.g., input/output circuits, communication circuits such as USB, ethernet, and Bluetooth, cryptography accelerators, display circuits, audio circuits, and the like). These networks may further include various network switches, routers, and interfaces for transferring transactions from the various source agents, including transferring these transactions across different ones of the networks, to the various destination agents.

Based on current operating parameters such as voltage of a power supply signal and frequency of clock signal, communication fabric 140 has a current available bandwidth. In some embodiments, available bandwidth may be applicable for each network of communication fabric 140. For example, the different networks may have different power and/or clock signals, and based on the current operating parameters, the processor and memory networks may have a highest available bandwidth while the peripheral network is placed in a lower performance state with a lower available bandwidth than the processor and memory networks.

As shown, agent circuits 110 may be configured to issue real-time (RT) transactions in accordance with the current available bandwidth. RT transactions may have a higher priority than other transactions. For example, agent circuits 110 may include one or more of a display controller circuit, a camera circuit, an image signal processing circuit, an audio circuit, and a codec circuit. When active, a camera circuit may stream video output to a memory circuit for consumption by a display controller, thereby allowing a user of an associated device to see what the camera is capturing. To avoid delays and/or glitches, this video data may be sent across communication fabric 140 using RT transactions rather than standard (e.g., bulk or “best effort”) transactions.

Performance management circuit 101, as illustrated, may be configured to determine a current available bandwidth of communication fabric 140 and allocate, based on this current available bandwidth, respective bandwidth usage targets 150 to respective ones of agent circuits 110. In some embodiments, these bandwidth usage targets may be in the form of latency tolerances indicating a minimum latency the respective agent circuits 110 must be capable of tolerating without experiencing an output overload (e.g., a source agent running out of data space in a transmit buffer) or input underrun (e.g., a destination agent running out of data to process from an input buffer). If a target latency tolerance is one microsecond, then a source agent should take appropriate measures (e.g., issuing read/write requests at higher than its required bandwidth) to ensure, e.g., that no underrun or overflow of data will occur if transactions experience a latency of up to one microsecond.

As shown, debug circuit 160 may be configured to access, during an active debug session, operational states of agent circuits 110. For example, if a developer or test engineer is operating a system that includes SOC 100, they may use a particular debugger system that places SOC into an active debug mode, thereby allowing greater visibility of the operation of SOC 100 so the developer or engineer may determine how SOC 100 is performing in response to a particular set of stimuli. Debug circuit may be configured to access and capture at least a portion of registers and/or memory circuits of the various agent circuits 110 and transfer these captured contents to the debugger system for the developer/engineer to analyze. One particular issue for which a debugger system may be utilized is mismatches between an assigned target latency tolerance and actual current latency tolerance indicated by agent circuits 110.

A given one of agent circuits 110 (e.g., agent circuit 110a) may be configured to determine that a respective bandwidth usage target 150 received from performance management circuit 101 is insufficient for current activity being performed by agent circuit 110a. As illustrated, LED 120a may be configured to monitor agent circuit 110a for signs of an impending data overload (source agent) and/or underrun (destination agent). For example, LED 120a may monitor currently available space in data input and output buffers associated with agent circuit 110a. When an output buffer reaches, e.g., 95% capacity, or an input buffer falls to, e.g., 2% capacity, LED 120a may determine that bandwidth usage target 150 is insufficient for the current workload. In other embodiments, a buffer occupancy rate over time may be used to identify an impending data overload/underrun based on a current data generation/consumption rate of agent circuit 110a. In some embodiments, signs of an impending data overload (source agent) and/or underrun (destination agent) may include determining that agent circuit 110a fails to reach the bandwidth usage target 150 over a particular time period, e.g., agent circuit 110a is failing to “catch up” to the target value.

Based on this determination, agent circuit 110a, or more specifically SSC 130a, may be configured to capture a set of current values from one or more registers in agent circuit 110a. For example, LED 120a may, in response to the determination, assert a trigger signal causing SSC 130a to capture a current “snapshot” of relevant registers in agent circuit 110a. In some embodiments, these one or more registers may be accessed without affecting a state of the one or more registers. For example, some status and control registers may have a respective bit or bits that may set or reset when a particular register or registers are read or written, or a particular buffer register may be cleared after being read. Accordingly, SSC 130a is configured to access, in response to the determination that bandwidth usage target 150 is insufficient, such registers without altering the registers themselves or any associated status and/or control registers.

In various embodiments, values from all or only a portion of registers in agent circuit 110a may be captured. For example, a subset of registers in agent circuit 110a may be ephemeral, so these registers may be prioritized to capture since their values may change if not accessed quickly. Other data values may also be captured such as a current timestamp, a current value of bandwidth usage target 150, and/or a value of a current latency tolerance of agent circuit 110a. Additional details of data included in a snapshot are provided below.

It is noted that particular agent circuits, such as agent circuits 110b and 110d, may have multiple SSCs 130. Agent circuit 110b, for example, may include SSC 130ba to capture a first set of associated register values while SSC 130bb is included to capture a second set of associated register values, the second set being exclusive from the first set. Agent circuits 110b and 110d may be physically large relative to agent circuits 110a and 110c, and therefore use of two or more SSCs 130 may be easier than routing all necessary register signals to a single SSC 130. Routing a single trigger signal from LED 120b or 120d to the associated SSCs 130 may, therefore, be easier to implement and/or use less die area than routing register signals to a single SSC 130. Furthermore, agent circuits 110b and 110d may include a much larger number of registers that are desired to be captured than agent circuits 110a and 110c. Having multiple SSCs 130 may also be easier to implement in such cases.

After SSC 130a has captured the set of current values of the relevant registers, the set of current values may be stored in locations that are accessible via communication fabric 140. For example, another of agent circuits 110 (e.g., 110d), may be capable of requesting any portion of the captured values. Agent circuit 110d may, for example, be a processor core executing a particular application that makes use of agent circuit 110a. The application may include software that polls SSC 130a or receives an indication that SSC 130a has captured the set of current values, and in response, may read some or all of the set. Such information may allow the application to adjust a usage profile of agent circuit 110a to get the current latency tolerance of agent circuit 110a to a value that satisfies the bandwidth usage target 150.

In some embodiments, after SSC 130a has captured the set of current values of the relevant registers, agent circuit 110a may be configured to send at least a portion of the set of current values to debug circuit 160. In some embodiments, SSC 130a may transfer, via communication fabric 140 or in other embodiments, via a backchannel such as a debug network, the set of current values once the set has been captured. In other embodiments, debug circuit 160 may request the set of values from SSC 130a. Debug circuit 160 may be configured to store the set of current values in buffer circuit 165. The developer/engineer may use the debugger system to retrieve the set of current values from buffer circuit 165.

Furthermore, agent circuit 110a may also be configured to, based on the determination that bandwidth usage target 150 is insufficient, cease further processing to maintain a current state. For example, agent circuit 110a may, if currently acting as a source agent, temporarily cease generation of additional data to be sent via communication fabric 140. If currently acting as a destination agent, then agent circuit 110a may cease processing of data from an associated input buffer. By freezing a state of agent circuit 110a, a user may be able to inspect, e.g., via debug circuit 160, the current state of agent circuit 110a to determine the cause of the target latency tolerance miss.

It is noted that SOC 100, as illustrated in FIG. 1, is merely an example. SOC 100 has been simplified to highlight features relevant to this disclosure. Elements not used to describe the details of the disclosed concepts have been omitted. For example, SOC 100 may include various circuits that are not illustrated, such as one or more processor circuits, memory management circuits, memory circuits, and the like. In various embodiments, circuits of SOC 100 may be implemented using any suitable combination of sequential and combinatorial logic circuits. In addition, register and/or memory circuits, such as static random-access memory (SRAM) may be used in these circuits to temporarily hold information such as instructions, data, address values, and the like.

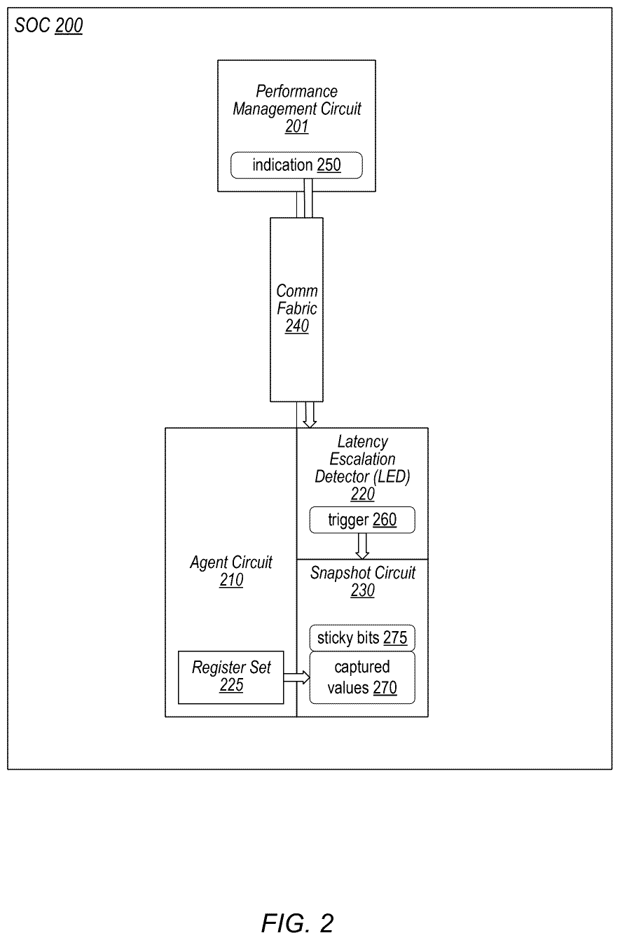

In FIG. 1, an SOC that utilizes latency escalation detectors and snapshot circuits to identify and capture states of agent circuits is disclosed. Such circuits may be implemented in a variety of fashions and may be used to capture various pieces of information that may be used to identify operational issues in an SOC. FIG. 2 depicts an example of how latency escalation detectors and snapshot circuits may identify when an agent circuit has a target to actual latency tolerance mismatch and how data may be captured without impacting a current state of the agent circuit.

Moving to FIG. 2, a block diagram of another embodiment of an SOC that uses a latency escalation detector circuit to identify a target latency mismatch and a snapshot circuit to capture relevant data is illustrated. SOC 200 includes performance management circuit 201, agent circuit 210, communication fabric 240, latency escalation detector (LED) circuit 220, and snapshot circuit 230. It is noted that the elements of FIG. 2 may correspond, in some embodiments, to similarly named and numbered elements of FIG. 1. Operation of these circuits may be as described above with exceptions disclosed below.

As shown, agent circuit 210 may be configured to receive, from performance management circuit 201, indication 250 that indicates a current usage target for communication fabric 240, coupled to agent circuit 210. As described for communication fabric 140, communication fabric 240 may be configured to support transactions between agent circuit 210 and other circuit blocks included in SOC 200 (but not illustrated). Agent circuit 210 may be configured issue real-time (RT) transactions via the communication fabric in accordance with indication 250. Agent circuit 210 includes register set 225 which may include various types of register as is suitable for different types of agent circuits. For example, a processor core may include a register file for holding operands and addresses associated with instructions being processed, one or more condition code registers, and various status and control registers. An image signal processor may include an input buffer to hold pixel data for an image being processed, status and control registers for determining types of processing to perform, an output buffer to store pixel data that has been processed, and so forth.

LED circuit 220, as illustrated, is coupled to agent circuit 210, in various embodiments, LED circuit 220 may be included within agent circuit 210 as a sub-module, or may be a separate circuit coupled to agent circuit 210. In the latter case, LED circuit 220 may be closely coupled to agent circuit 210 using multiple signals to provide access to circuits used to identify a latency tolerance mismatch event within agent circuit 210. LED circuit 220 may be configured to receive indication 250 provided by performance management circuit 201, and use indication 250 to determine that the indicated current available bandwidth is insufficient for tasks assigned to agent circuit 210. For example, LED circuit 220 may be capable of determining a condition in agent circuit 210 in which agent circuit 210 has one or more transactions ready to send but is unable to transfer these transactions due to unavailability of communication fabric 240. Agent circuit 210 may include an output buffer for holding transactions to be sent and/or may use a network interface to gain access to communication fabric 240. In some embodiments, LED circuit 220 may be configured to compare indication 250 with a current latency tolerance calculated for agent circuit 210. If the current latency tolerance exceeds indication 250 for a threshold amount of time, LED circuit 220 may determine that the current available bandwidth is insufficient to meet a target established by indication 250.

Based on a determination that the indicated current available bandwidth is insufficient, LED circuit 220 may be configured to assert trigger 260. For example, LED circuit 220 may assert trigger 260 if the unavailability of communication fabric 240 last for a threshold amount of time, and/or if a threshold number of transactions are waiting to be sent. In some embodiments, LED circuit 220 may determine that an output buffer has reached a threshold level of capacity.

If agent circuit 210 is acting as a destination agent, then LED circuit 220 may assert trigger 260 if an input buffer has fallen to a threshold level of emptiness, and/or if no transactions have been received for a threshold amount of time. It is noted that some agent circuits may act as both source agents and destination agents. For example, a graphics processor unit (GPU) may be a destination agent for image data captured by a camera circuit. The GPU may be a source agent after processing this received image data by sending the processed image data to a display interface. Similarly, a central processing unit (CPU) may be a destination agent for instructions and data related to a program being executed in the CPU. Execution of this program may result in the CPU acting as a source agent by sending output data to one or more memory circuits in SOC 200.

As illustrated, snapshot circuit 230 is coupled to agent circuit 210 and may be configured to, based on the assertion of trigger 260, capture current values from register set 225 in agent circuit 210. In some embodiments, snapshot circuit 230 may retrieve captured values 270 without affecting a state of register set 225. To retrieve a corresponding one of captured values 270 from a given register of register set 225, snapshot circuit 230 may set a respective one of sticky bits 275. Additional writes to the given register of register set 225 may be blocked while the respective sticky bit is set, thereby preserving the state of the given register at the time trigger 260 is asserted. In addition, logic circuits that cause a state change in response to accessing the given register may be blocked, thereby preventing any change to any associated register when snapshot circuit 230 reads the given register. Accordingly, any change based on a read access of the given register is prevented, thereby preserving a state of registers associated with the given register. For example, register set 225 may include a data output register that retains a stored value until the data output register is read. A read of the data output register may then clear the register and allow a new value to be stored. In addition, register set 225 may include a status register that asserts a particular bit to indicate that the data output register has a value that has yet to be read. The same read that clears the data output register may also clear this status bit. When snapshot circuit 230 sets a respective sticky bit for the data output register, the logic that clears the register and the status bit in response to a read may be disabled or otherwise blocked. Snapshot circuit 230 may then read the preserved value of the data output register without clearing the data output register or the associated status bit.

In some embodiments, the read of the given register by snapshot circuit 230 may reset the respective sticky bit, thereby allowing the given register to be updated after the preserved value has been added to captured values 270. Snapshot circuit 230 may include a respective one of sticky bits 275 for each register in register set 225. In other embodiments, one of sticky bits 275 may correspond to a plurality of registers in register set 225. In the latter case, a sticky bit may not be reset until all associated registers are read by snapshot circuit 230.

It is noted that the SOC depicted in FIG. 2 is simplified for clarity. In other embodiments, SOC 200 may include a variety of other circuits, such as processors, memory circuits, clock generation circuits, various peripherals, and the like.

FIGS. 1 and 2 depict respective embodiments of SOCs that utilize LED circuits and snapshot circuits to monitor current latency tolerances to identify impending issues. Operation of these circuits may vary in these different embodiments. FIG. 3 depicts an example of what types of data may be captured when a tolerance issue is detected.

Continuing to FIG. 3, a block diagram of a third embodiment of an SOC that uses a latency escalation detector circuit to identify a target latency mismatch and a snapshot circuit to capture relevant data is shown. SOC 300 includes performance management circuit 301, agent circuits 310a and 310b (collectively 310), communication fabric 340, latency escalation detector (LED) circuits 320a, 320b, and 320d (collectively 320), and snapshot circuits 330a-330d (collectively 330). It is noted that the elements of FIG. 3 may correspond, in some embodiments, to similarly named and numbered elements of FIGS. 1 and 2. Operation of these circuits may be as described above with exceptions disclosed below.

As illustrated, performance management circuit 301 may be configured to determine a bandwidth usage target for communication fabric 340. Various parameters may be considered by performance management circuit 301 to determine the bandwidth usage target. For example, the bandwidth may be limited based on a capacity of a memory circuit coupled to communication fabric 340. The memory circuit may include a dynamic random-access memory (DRAM) controller that is commonly used as a source or destination for transactions transferred via communication fabric 340. In various embodiments, a single bandwidth usage target may be determined for communication fabric 340 and then divided and allocated among agent circuits 310 and performance management circuit. The respective bandwidth usage targets may include corresponding target latency tolerances 350 for RT transactions. In some embodiments, a respective target latency tolerance for agent circuit 310a may be different than a target latency tolerance for agent circuit 310b. In other embodiments, target latency tolerance 350 may be a single value for all agent circuits 310 as well as for performance management circuit 301. The target latency tolerances 350 may be distributed to agent circuits 310 and/or to LEDs 320.

A given agent circuit may be further configured to determine that current activity will not satisfy the respective target latency tolerance 350. For example, agent circuit 310b may determine current latency tolerance 355b based on current activity, such as a particular task being performed by agent circuit 310b. If the current activity does not rely on a large number of RT transactions being sent and/or received, then current latency tolerance 355b may be a high value, indicating that agent circuit 310b is currently very tolerant to high latencies for RT transactions. In contrast, the current activity may rely heavily on a large number of RT transactions being sent and/or received, resulting in current latency tolerance 355b being a low value, indicating that agent circuit 310b is currently very sensitive to high latencies for RT transactions.

Agent circuit 310b may send current latency tolerance 355b to LED circuit 320b. In other embodiments, LED circuit 320b may retrieve current latency tolerance 355b from agent circuit 310b, e.g., periodically and/or in response to an indication that an updated value of current latency tolerance 355b is available. LED circuit 320b may then determine that current latency tolerance 355b for agent circuit 310b does not satisfy target latency tolerance 350. For example, if target latency tolerance 350 is higher than current latency tolerance 355b, then agent circuit 310b has a latency tolerance mismatch and asserts trigger 360b. In some embodiments, LED circuit 320b may determine whether the detected latency tolerance mismatch persists for a threshold amount of time before asserting trigger 360b.

Agent circuit 310b may be further configured to, based on the determination that the respective target latency tolerance 350 is insufficient, capture up-to-date values for current latency tolerance 355b and target latency tolerance 350. For example, trigger 360b may cause snapshot circuit 330b, that is coupled to agent circuit 310b, to capture relevant values from register set 315b and include these captured values in captured values 370b. In addition, snapshot circuit 330b may capture a current value of current latency tolerance 355b, and/or target latency tolerance 350. In some embodiments, snapshot circuit 330b may further capture a minimum determined value of current latency tolerance 355b. This minimum value may be determined as a minimum value determined for a current task being performed by agent circuit 310b, or a minimum value determined since a most recent system reset, or a minimum value determined over a predetermined time period, or determined over any other suitable boundary conditions.

In addition, snapshot circuit 330c, that is also coupled to agent circuit 310b, may be configured to, based on the assertion of trigger 360b, capture current values from register set 315c in agent circuit 310b without affecting a state of the registers in register set 315c. Register sets 315b and 315d may be mutually exclusive, and a number of values captured from register set 315b may be different than a number of values captured from register set 315c. The use of two or more snapshot circuits with a single agent circuit may allow a greater number of register values to be captured in parallel. If the agent circuit has a high number of registers, use of multiple snapshot circuits may reduce an amount of time it takes to capture all of the relevant values. This time to capture may be beneficial in embodiments in which the agent circuit has a plurality of registers that hold ephemeral values. For example, if the agent circuit includes registers that sample given values on a periodic basis, then it may be desired for snapshot circuits to capture the values that were valid at the latency tolerance mismatch was detected. Further to this point, some, or all, snapshot circuits in a given system may be configured to only capture values from registers with ephemeral values or to prioritize capturing ephemeral values over values from registers that may remain static for longer periods of time.

In some embodiments, snapshot circuits 330b and 330c may split responsibility for capturing additional information outside of register sets 315b and 315c. For example, snapshot circuit 330b may capture current latency tolerance 355b, as indicated in FIG. 3, while snapshot circuit 330c captures the most recent value of target latency tolerance 350 sent by performance management circuit 301. One or both of snapshot circuits 330b and 330c may further capture a minimum determined value of current latency tolerance 355b. This minimum value may be determined as a minimum value determined for a current task being performed by agent circuit 310b, or a minimum value determined since a most recent system reset, or a minimum value determined over a predetermined time period, or determined over any other suitable boundary conditions.

In some embodiments, agent circuit 310b may be further configured to, based on the determination that the respective target latency tolerance 350 is insufficient, change current latency tolerance 355b to a maximum value. By increasing current latency tolerance 355b to a maximum value, other agent circuits 310, such as a memory circuit, may be allowed to complete a transactions despite the determined latency tolerance mismatch in agent circuit 310b that might otherwise increase traffic and block the other agent circuits 310 from completing their tasks. For example, if agent circuit 310b is a GPU that is currently being used to stream video to a display controller, then increasing current latency tolerance 355b to a maximum value may result in cases of video frames freezing momentarily or skipping one or more video frames. The increase, however, may prevent the GPU from creating excess traffic in communication fabric 340 and free bandwidth for other agent circuits 310 to complete their respective tasks. Other congestion on communication fabric 340 or in one or more memory circuits may be allowed to clear, which, in turn, may reduce transaction latencies for the GPU and the video may then resume playing.

In some embodiments, agent circuit 310b may be further configured to, based on the determination that the respective target latency tolerance 350 is insufficient, assert an interrupt signal. For example, LED circuit 320b (as well as the other LEDs 320) may include a configuration option that allows for asserting an interrupt signal in parallel with trigger 360b. Such an option may allow for an interrupt handler program to further gather information related to the latency tolerance event and, for example, activate a debug program, thereby allowing a user to analyze conditions that led to the event.

It is noted that the embodiment of FIG. 3 is merely an example. Although two agent circuits are shown, any suitable number of agent circuits may be included in SOC 300. Snapshot circuit 330d and LED circuit 320d may be included within the performance management circuit 301, as a separate block coupled to performance management circuit 301, or a combination thereof.

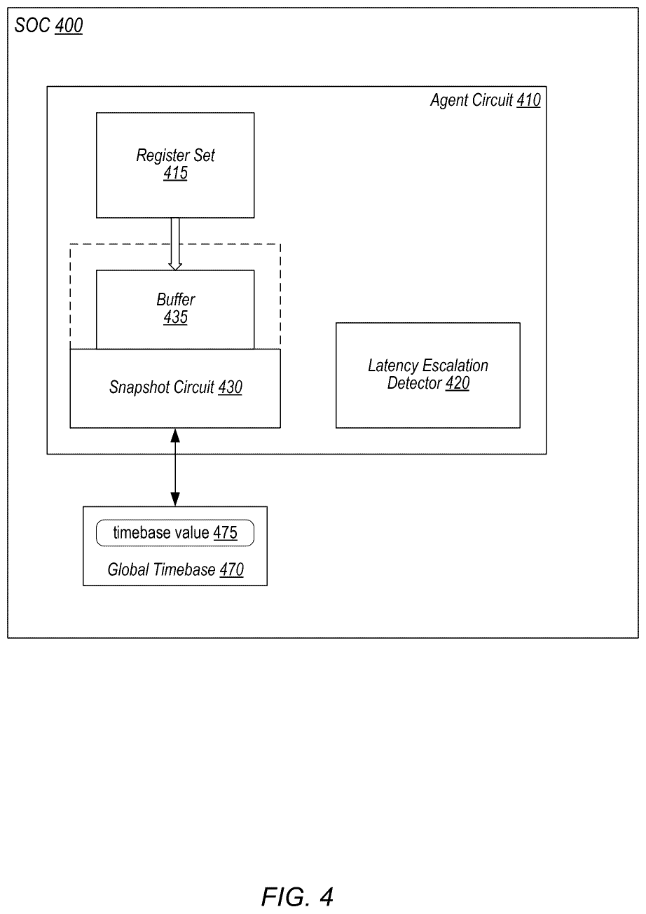

FIGS. 1-3 depict respective embodiments of SOCs that utilize LED circuits and snapshot circuits to manage latency tolerances. Various features have been disclosed regarding structure and operation of contemplated embodiments. In FIG. 4, additional features that may be incorporated into systems utilizing the disclosed techniques are shown.

Proceeding to FIG. 4, a block diagram of a fourth embodiment of an SOC that uses a latency escalation detector circuit and a snapshot circuit is illustrated. SOC 400 includes agent circuit 410 and global timebase 470. Agent circuit 410 includes latency escalation detector (LED) circuit 420, snapshot circuit 430, and register set 415. In various embodiments, snapshot circuit 430 either includes or is coupled to buffer circuit 435 that may be used to store values captured by snapshot circuit 430. As previously described for the prior FIGS., the elements of FIG. 4 may correspond to similarly named and numbered elements of FIGS. 1-3. Operation of these circuits may be as described above with exceptions disclosed below.

In the descriptions above, the snapshot circuits are disclosed as capturing values from a register set in a respective agent circuit after a latency tolerance mismatch event has occurred. In some cases, however, a cause of such an event may be traced back to operations performed before the event is detected. Furthermore, in some of these cases, visibility of the cause may be lost by the time the latency escalation detector circuits assert a trigger and respective snapshot circuits capture associated register values.

In some embodiments, therefore, snapshot circuit 430 may be configured to use buffer circuit 435 to capture a series of values from register set 415 in agent circuit 410, without affecting the state of registers in register set 415. Values from register set 415 may be captured before a trigger signal is asserted by LED circuit 420, and then stored in buffer circuit 435. For example, snapshot circuit 430 may be configured to capture a series of values based on a periodic sampling of a number of system clock cycles and/or an amount of time. In addition to, or in place of, a periodic sample of register set 415, snapshot circuit 430 may be configured to capture a given set of values from register set 415 based on a determination that a state of agent circuit 410 has changed. Snapshot circuit 430 may determine if one or more particular registers (or any register) of register set 415 is written to and/or otherwise changes value. In response to a change in value one or more of the particular registers, snapshot circuit 430 captures the new value(s).

Based on a size of buffer circuit 435, a series of samples may be stored at any given time. If a latency tolerance mismatch event occurs, then snapshot circuit 430 may be configured to send some or all of the series of samples to a debug circuit (e.g., debug circuit 160 in FIG. 1). In some embodiments, buffer circuit 435 may be read, e.g., via requests from the debug circuit, at any particular time during operation. If buffer circuit 435 does not have sufficient available storage to hold values from a latest sample, then an oldest sample may be evicted and replaced with the new sample. In other cases, eviction may be based on different criteria, such as evicting a sample in which a small number of sampled registers with changed values from the previous and/or subsequent samples.

In addition to captured register values, timing may of a particular sample may be of interest. Accordingly, in some embodiments, agent circuit 410 may be further configured to, based on a determination that a respective bandwidth usage target is insufficient, capture a current timebase value 475. In other embodiments, such a timebase value may be captured by snapshot circuit 430 at every sample. Global timebase 470 may be a clock circuit or other form of timekeeping circuit that provides circuits of SOC 400 with a system-wide value indicative of a passage of time, as represented by a current value of timebase value 475. Inclusion of timebase value 475 may allow a user of SOC 400 (e.g., a developer or engineer) to piece together a view of operations performed by agent circuit 410. Furthermore, inclusion of timebase values may allow information retrieved from a plurality of snapshot circuits throughout SOC 400 to be analyzed relative in time to one another, further providing insight into overall operation of SOC 400.

It is noted that SOC 400 of FIG. 4 is an example to demonstrate various circuits and techniques disclosed herein. The depiction of SOC 400 has been simplified for clarity. In other embodiments, various additional circuits may be included, such as communication fabrics, performance management circuits, and the like. It is further noted that the latency escalation detector circuits and snapshot circuits disclosed herein may be programmable, thereby allowing a user to select, for example, which registers are sampled, whether a timebase value is captured, if and how frequently samples may be captured, and so forth. In such embodiments, individual agent circuits may be programmed independently to capture more or less information than other agent circuits. In addition, conditions for asserting a respective trigger may be programmable, further allowing a use to, for example, enable triggering by a subset of the agent circuits to focus debug efforts on this subset. Such programmability may further enable latency escalation detectors to trigger when a particular pattern of one or more programmed patterns is detected. In other embodiments, some or all of the available options may be enabled or disabled based on a circuit implementation.

In the embodiments of FIGS. 1-4, latency escalation detectors are used to detect an escalation in transaction latency and predict an impending issue that could result in a data overrun or underrun. It is contemplated, however, that the disclosed latency escalation detectors (e.g., LEDs 120, 220, 320, and 420) could be replaced with or accompanied by other types of condition detection circuits. For example, a temperature escalation detection circuit may be used to track frequent temperature-related power mode changes. In some embodiments, a performance management circuit, such as performance management circuits 101-301 in FIGS. 1-3, may change a performance state of an SOC (including, e.g., reducing one or more power supply voltage levels and/or clock frequencies) in response to a determination that a temperature of the SOC satisfies a threshold level. Occasional occurrences of such thermal events may be tolerable with an acceptable impact to overall SOC performance. However, frequent occurrences may cause an unacceptable impact to performance and, therefore, determining a cause of the frequent occurrences may be desired to determine a long-term solution for avoiding the thermal events.

Accordingly, a thermal escalation detection circuit may be used to monitor occurrences of thermal events that result in a performance state change that impacts a respective agent circuit. Such a thermal escalation detection circuit may use a rolling window to track a number of occurrences impacting the respective agent within the rolling window and assert a trigger based on a determination that a current number of occurrences within the current window satisfies a threshold number. A snapshot circuit, as described above, may then be used to capture a current state of the respective agent circuit. In some embodiments the captured values may be read by a debug circuit thereby allowing an engineer or developer to understand conditions of various agent circuits across the SOC when the trigger was asserted. In other embodiments, The asserted trigger may, in addition, cause the performance management circuit to change to a different state when similar conditions are encountered, or may increase/decrease one or more threshold values that establish a hysteresis between performance state changes. For example, a value of a temperature reading that must be reached before allowing the performance state to be changed back to a higher performance state may be lowered, thereby requiring the SOC to reach a lower temperature before returning to the higher performance state. Instead, or in addition, a time limit may be established or increased before returning to the higher performance state.

Other types of agent monitoring are also contemplated. For example, instead of thermal events, a detection circuit may track bandwidth demand of a memory system. A given SOC may include and/or be coupled to one or more memory systems, each memory system having a respective memory access controller circuit. A bandwidth escalation detection circuit may, in a similar manner as described for the thermal events, track occurrences of bandwidth demand that satisfies a threshold level. If a total number of occurrences over current window satisfies a threshold number of occurrences, then the bandwidth escalation detector circuit may assert a trigger thereby causing respective snapshot circuits to capture current values associated with the respective memory access controller circuit. Again, captured values may be readable via a debug circuit for use by engineers and developers. Other actions may further include redistributing memory allocation from memory systems with high demand to memory systems with low demand.

Another type of agent monitoring may include detection of particular types of hacking attacks. For example, one type of attack, commonly referred to as “row hammering,” involves hackers running code on a device that causes repeated accesses to a particular portion of a memory circuit (e.g., a memory row) with intent to cause a memory access error that the hacker may then use to gain control of the instruction flow by redirecting instruction fetches to the hacker's code. Since frequently repeated accesses to a small portion of a memory circuit is not common in legitimate programs, a memory access escalation circuit may be used to track a number of access to a given address range within a particular window of time. If the number of accesses satisfies a threshold number within the particular window of time, the corresponding trigger is asserted. To help prevent a successful attack, the assertion of the trigger may cause an exception to be taken, thereby diverting the instruction flow away from the hacker's code an into a security process that can shutdown program execution, cause a system reset, put the SOC into a lockdown mode, and/or other implement other security measures. Such memory access escalation circuits may be associated with respective memory systems or subsystems, thereby allowing for independent monitoring of multiple memory circuits.

Further contemplated uses for similar monitoring techniques may include tracking of memory bit errors. Bit errors may occur in various memory circuits due to a variety of reasons. Noise on power supply signals, glitches on clock signals, excessive time between memory refreshes, and other events may cause SRAM and/or DRAM bit cells to flip state, resulting in a bit error when a location with a flipped bit is read. Flash memory circuits may be susceptible to data retention and/or read/write cycling errors over a period of use, similarly resulting in a bit error when a location with a flipped bit is read. A bit-error escalation circuit may be configured to track a number of memory-read bit errors that occur over a given window of time for a respective memory circuit. If the number of bit errors within a current window satisfies a respective threshold, then a corresponding trigger may be asserted, a snapshot captured, and appropriate action taken. For example, the snapshot may capture respective addresses of the bit errors. If a majority of the bit errors are associated with a single bit at a particular address, then a memory repair operation may be performed, e.g., remapping the failing bit to a spare memory cell. If the majority of bit errors are distributed within a single memory block, then the failing memory block may be disabled.

To summarize, various embodiments of a system that utilizes one or more latency escalation detectors circuit are disclosed. In an example apparatus, a computer system is implemented on one or more co-packaged integrated circuit dies, the computer system including a communication fabric, a plurality of agent circuits, a performance management circuit, and a debug circuit. The communication fabric may be configured to transfer transactions from source circuits to destination circuits, wherein the communication fabric has a current available bandwidth. The plurality of agent circuits may be configured to issue real-time (RT) transactions in accordance with the current available bandwidth. RT transactions may have a higher priority than other transactions. The performance management circuit may be configured to allocate, based on the current available bandwidth, respective bandwidth usage targets to respective ones of the plurality of agent circuits. The debug circuit may be configured to access operational states of the plurality of agent circuits. A given one of the agent circuits may also be configured to, based on a determination that the respective bandwidth usage target is insufficient for current activity, capture a set of current values from one or more registers in the given agent circuit without affecting a state of the one or more registers. The given agent circuit may then send at least a portion of the set of current values to the debug circuit.

In a further example, the respective bandwidth usage targets may include corresponding target latency tolerances for RT transactions. To determine that the respective bandwidth usage target is insufficient, the given agent circuit may also be configured to determine a current latency tolerance based on current activity. The given agent circuit may be further configured determine that the current latency tolerance is insufficient to satisfy the respective target latency tolerance.

In another example, the given agent circuit may be further configured to, based on the determination that the respective bandwidth usage target is insufficient, capture up-to-date values for the current and target latency tolerances, and a minimum determined value of the current latency tolerance. In a further example, the given agent circuit may also be configured to, based on the determination that the respective bandwidth usage target is insufficient, change the current latency tolerance to a maximum value.

In an example, the given agent circuit may also be configured to, based on the determination that the respective bandwidth usage target is insufficient, capture a current global timestamp value. In another example, the given agent circuit may be further configured to, based on the determination that the respective bandwidth usage target is insufficient, cease further processing to maintain a current state.

In a further example, the given agent circuit may also be configured to, based on the determination that the respective bandwidth usage target is insufficient, assert an interrupt signal. In an embodiment, the given agent circuit may be further configured to set a respective sticky bit for ones of the set of captured values. The given agent circuit may also be configured to block additional writes to a given one of the one or more registers while the respective sticky bit is set. Based on a read access of the given register, the given agent circuit may be further configured to reset the respective sticky bit.

In an example, the given agent circuit may include a snapshot buffer circuit. The snapshot buffer circuit may be configured to capture a series of values from the one or more registers in the given agent circuit without affecting the state of the one or more registers, and store the series of values in the snapshot buffer circuit. In further example, to capture the series of values, the snapshot buffer circuit may be further configured to capture a given set of values from the one or more registers based on a determination that a state of the given agent circuit has changed.

In an example, the computer system is configured to operate as a single system-on-chip across the plurality of co-packaged integrated circuit dies. The plurality of agent circuits may be distributed across the plurality of co-packaged integrated circuit dies. In an example, the plurality of agent circuits may include one or more of: a display controller circuit, a camera circuit, an image signal processing circuit, an audio circuit, and a codec circuit.

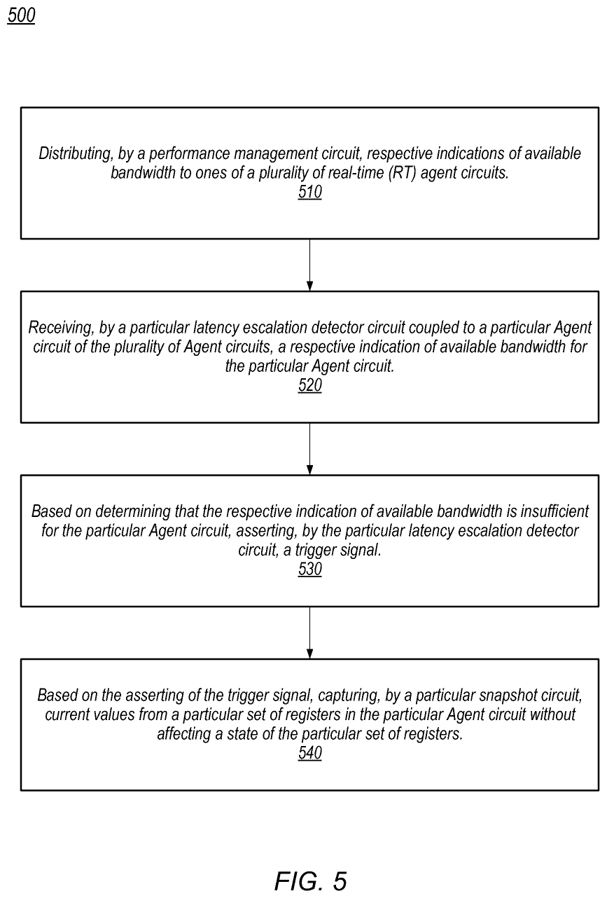

The circuits and techniques described above in regards to FIGS. 1-4 may be performed using a variety of methods. A method associated with using selectable lockup latch circuits is described below in regard to FIG. 5.

Turning now to FIG. 5, a flow diagram for an embodiment of a method for operating a latency escalation detector circuit and a snapshot circuit is illustrated. Method 500 may be performed by any of the systems disclosed herein, including SOCs 100-400 of FIGS. 1-4. In some embodiments, some or all of the operations of method 500 may be performed using instructions included in a non-transient, computer-readable memory having program, the instructions being executable by processor circuits in the systems to cause the operations described with reference to FIG. 5. Method 500 is described below using SOC 300 of FIG. 3 as an example. References to elements in FIG. 3 are included as non-limiting examples.

At 510, method 500 begins by performance management circuit distributing respective indications of available bandwidth to ones of a plurality of agent circuits included in a computer system implemented on one or more co-packaged integrated circuit dies. For example, performance management circuit 301 may determine a bandwidth capacity for communication fabric 340 based on current operating parameters in SOC 300. An amount of data that communication fabric 340 is capable of transferring over a given amount of time may depend, e.g., on a clock frequency associated with the fabric. Performance management circuit 301 may then determine respective target latency tolerances 350 for individual ones of agent circuits 310. Performance management circuit 301 may use information such as current tasks being performed by agent circuits 310 and/or other circuits coupled to communication fabric 340 to determine a plurality of target latency tolerances 350. In some embodiments, performance management circuit 301 may distribute the respective ones of target latency tolerances 350 to one of agent circuits 310. Such target latency tolerances 350 may indicate to the respective agent circuits 310 a maximum latency to expect for sending and/or receiving transactions via communication fabric 340.

Method 500 continues at 520 with a latency escalation detector circuit, coupled to a given agent circuit of the plurality of agent circuits, receiving a respective indication of available bandwidth for the given agent circuit. For example, LED circuit 320b in agent circuit 310b may receive a respective one of target latency tolerances 350 for use with agent circuit 310b. The respective target latency tolerance 350 for agent circuit 310b may include an indication of a transaction latency that agent circuit 310b should be able to withstand without experiencing a data underrun when receiving transactions, or a transmit buffer overload when sending transactions. The target latency tolerances 350 may indicate an amount of time for completing transactions via communication fabric 340.

At 530 method 500 proceeds with the latency escalation detector circuit asserting a trigger signal based on determining that the respective indication of available bandwidth is insufficient for the given agent circuit. For example, determining that the respective target latency tolerance 350 is insufficient may include determining, by LED circuit 320b, a current latency tolerance 355b based on current activity in agent circuit 310b. LED circuit 320b may then determine that the determined current latency tolerance 350 for agent circuit 310b is insufficient to satisfy the respective target latency tolerance 355b, e.g., current latency tolerance 355b is less than the respective target latency tolerance 350. In response to such a determination, LED circuit 320b may assert trigger 360b.

Method 500 continues at 540 with a snapshot circuit capturing, based on the asserting of the trigger signal, current values from a set of registers in the given agent circuit without affecting a state of the set of registers. Snapshot circuit 330b (as well as snapshot circuit 330c, as shown in FIG. 3), may receive trigger 360b and, upon assertion, collect captured values 370b from register set 315b. Snapshot circuit 330c, likewise, may collect captured values 370c from register set 315c based on the assertion of trigger 360b. As previously described, snapshot circuits 330b and 330c may captures values for all, or a subset, of respective register sets 315b and 315c.

In some embodiments, snapshot circuit 330b and/or 330c may further capture, in response to the assertion of trigger 360b, up-to-date values for the current latency tolerance 355b and the respective target latency tolerance 350. In addition, a minimum determined value of current latency tolerance 355b. For example, LED circuit 320b may maintain a record of a lowest value determined for current latency tolerance 355b. When a newest determined value of current latency tolerance 355b is less than the recorded lowest value, the recorded lowest value may be replaced. Furthermore, snapshot circuit 330b and/or 330c may also capture a current timestamp indicative of a time at which trigger 360b was asserted.

In further embodiments, agent circuit 310b may also be configured to reduce, in response to the asserting of trigger 360b, activity that consumes available bandwidth. For example, LED circuit 320b may cause agent circuit 310b to suspend generating transactions to be sent in an effort to reduce traffic on communication fabric 340.

It is noted that the method of FIG. 5 includes blocks 510-540. Method 500 may end in block 540 or may repeat some or all blocks of the method. For example, method 500 may repeat blocks 510 to distribute updated values for target latency tolerances 350. Agent circuits 310 may repeat some or all of blocks 520-540 to determine whether a latency tolerance mismatch has occurred. In some embodiments, different instances of method 500 may be performed concurrently. For example, SOC 300 may include more than one performance management circuit, coupled to a different set of agent circuits.

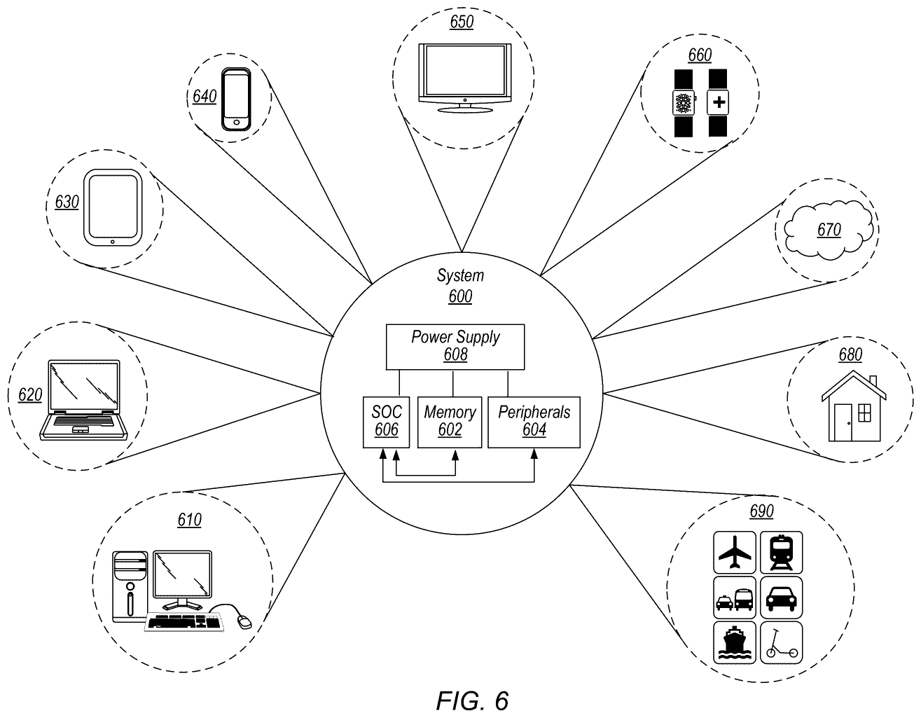

FIGS. 1-5 illustrate circuits and methods for a system, such as an integrated circuit, that include latency tolerance circuits and snapshot circuits for managing latency tolerance mismatches. Any embodiment of the disclosed systems may be included in one or more of a variety of computer systems, such as a desktop computer, laptop computer, smartphone, tablet, wearable device, and the like. In some embodiments, the circuits described above may be implemented on a system-on-chip (SOC) or other type of integrated circuit, including multi-die packages that include homogeneous and/or heterogeneous integrated circuits. A block diagram illustrating an embodiment of system 600 is illustrated in FIG. 6. System 600 may, in some embodiments, include any disclosed embodiment of systems disclosed herein, such as SOCs 100-400 shown in FIGS. 1-4.

In the illustrated embodiment, the system 600 includes at least one instance of a system on chip (SOC) 606 which may include multiple types of processor circuits, such as a central processing unit (CPU), a graphics processing unit (GPU), or otherwise, a communication fabric, and interfaces to memories and input/output devices. SOC 606 may correspond to an instance of the SOCs disclosed herein. In various embodiments, SOC 606 is coupled to external memory circuit 602, peripherals 604, and power supply 608.

A power supply 608 is also provided which supplies the supply voltages to SOC 606 as well as one or more supply voltages to external memory circuit 602 and/or the peripherals 604. In various embodiments, power supply 608 represents a battery (e.g., a rechargeable battery in a smart phone, laptop or tablet computer, or other device). In some embodiments, more than one instance of SOC 606 is included (and more than one external memory circuit 602 is included as well.

External memory circuit 602 is any type of memory, such as dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS DRAM (RDRAM), static RAM (SRAM), etc. In some embodiments, external memory circuit 602 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with a SOC or an integrated circuit in a chip-on-chip configuration, a package-on-package configuration, or a multi-chip module configuration.

The peripherals 604 include any desired circuitry, depending on the type of system 600. For example, in one embodiment, peripherals 604 includes devices for various types of wireless communication, such as Wi-Fi, Bluetooth, cellular, global positioning system, etc. In some embodiments, the peripherals 604 also include additional storage, including RAM storage, solid state storage, or disk storage. The peripherals 604 include user interface devices such as a display screen, including touch display screens or multitouch display screens, keyboard or other input devices, microphones, speakers, etc.

As illustrated, system 600 is shown to have application in a wide range of areas. For example, system 600 may be utilized as part of the chips, circuitry, components, etc., of a desktop computer 610, laptop computer 620, tablet computer 630, cellular or mobile phone 640, or television 650 (or set-top box coupled to a television). Also illustrated is a smartwatch and health monitoring device 660. In some embodiments, the smartwatch may include a variety of general-purpose computing related functions. For example, the smartwatch may provide access to email, cellphone service, a user calendar, and so on. In various embodiments, a health monitoring device may be a dedicated medical device or otherwise include dedicated health related functionality. In various embodiments, the above-mentioned smartwatch may or may not include some or any health monitoring related functions. Other wearable devices 660 are contemplated as well, such as devices worn around the neck, devices attached to hats or other headgear, devices that are implantable in the human body, eyeglasses designed to provide an augmented and/or virtual reality experience, and so on.

System 600 may further be used as part of a cloud-based service(s) 670. For example, the previously mentioned devices, and/or other devices, may access computing resources in the cloud (i.e., remotely located hardware and/or software resources). Still further, system 600 may be utilized in one or more devices of a home 680 other than those previously mentioned. For example, appliances within the home may monitor and detect conditions that warrant attention. Various devices within the home (e.g., a refrigerator, a cooling system, etc.) may monitor the status of the device and provide an alert to the homeowner (or, for example, a repair facility) should a particular event be detected. Alternatively, a thermostat may monitor the temperature in the home and may automate adjustments to a heating/cooling system based on a history of responses to various conditions by the homeowner. Also illustrated in FIG. 6 is the application of system 600 to various modes of transportation 690. For example, system 600 may be used in the control and/or entertainment systems of aircraft, trains, buses, cars for hire, private automobiles, waterborne vessels from private boats to cruise liners, scooters (for rent or owned), and so on. In various cases, system 600 may be used to provide automated guidance (e.g., self-driving vehicles), general systems control, and otherwise.

It is noted that the wide variety of potential applications for system 600 may include a variety of performance, cost, and power consumption requirements. Accordingly, a scalable solution enabling use of one or more integrated circuits to provide a suitable combination of performance, cost, and power consumption may be beneficial. These and many other embodiments are possible and are contemplated. It is noted that the devices and applications illustrated in FIG. 6 are illustrative only and are not intended to be limiting. Other devices are possible and are contemplated.

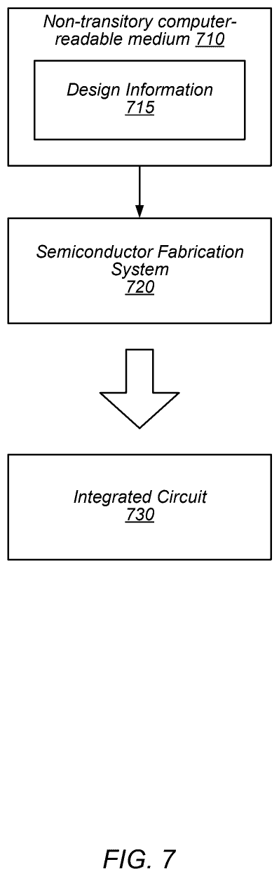

As disclosed in regards to FIG. 6, system 600 may include one or more integrated circuits included within a personal computer, smart phone, tablet computer, or other type of computing device. A process for designing and producing an integrated circuit using design information is presented below in FIG. 7.

FIG. 7 is a block diagram illustrating an example of a non-transitory computer-readable storage medium that stores circuit design information, according to some embodiments. The embodiment of FIG. 7 may be utilized in a process to design and manufacture integrated circuits, for example, including one or more instances of SOCs (or portions thereof) 100-400 as shown in FIGS. 1-4. In the illustrated embodiment, semiconductor fabrication system 720 is configured to process the design information 715 stored on non-transitory computer-readable storage medium 710 and fabricate integrated circuit 730 based on the design information 715.

Non-transitory computer-readable storage medium 710, may comprise any of various appropriate types of memory devices or storage devices. Non-transitory computer-readable storage medium 710 may be an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 710 may include other types of non-transitory memory as well or combinations thereof. Non-transitory computer-readable storage medium 710 may include two or more memory mediums which may reside in different locations, e.g., in different computer systems that are connected over a network.

Design information 715 may be specified using any of various appropriate computer languages, including hardware description languages such as, without limitation: VHDL, Verilog, SystemC, SystemVerilog, RHDL, M, MyHDL, etc. Design information 715 may be usable by semiconductor fabrication system 720 to fabricate at least a portion of integrated circuit 730. The format of design information 715 may be recognized by at least one semiconductor fabrication system, such as semiconductor fabrication system 720, for example. In some embodiments, design information 715 may include a netlist that specifies elements of a cell library, as well as their connectivity. One or more cell libraries used during logic synthesis of circuits included in integrated circuit 730 may also be included in design information 715. Such cell libraries may include information indicative of device or transistor level netlists, mask design data, characterization data, and the like, of cells included in the cell library.

Integrated circuit 730 may, in various embodiments, include one or more custom macrocells, such as memories, analog or mixed-signal circuits, and the like. In such cases, design information 715 may include information related to included macrocells. Such information may include, without limitation, schematics capture database, mask design data, behavioral models, and device or transistor level netlists. As used herein, mask design data may be formatted according to graphic data system (gdsii), or any other suitable format.

Semiconductor fabrication system 720 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 720 may also be configured to perform various testing of fabricated circuits for correct operation.

In various embodiments, integrated circuit 730 is configured to operate according to a circuit design specified by design information 715, which may include performing any of the functionality described herein. For example, integrated circuit 730 may include any of various elements shown or described herein. Further, integrated circuit 730 may be configured to perform various functions described herein in conjunction with other components.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A system comprising:
a computer system implemented on one or more co-packaged integrated circuit dies, the computer system including:
a communication fabric configured to transfer transactions from source circuits to destination circuits, wherein the communication fabric has a current available bandwidth;
a plurality of agent circuits configured to issue real-time (RT) transactions in accordance with the current available bandwidth, wherein RT transactions have a higher priority than other transactions; and
a performance management circuit configured to allocate, based on the current available bandwidth, respective bandwidth usage targets to respective ones of the plurality of agent circuits; and
wherein a given one of the agent circuits is configured to:
based on a determination that current activity does not satisfy the respective bandwidth usage target, capture a set of current values from one or more registers in the given agent circuit without affecting a state of the one or more registers; and
store the set of current values in locations that are accessible via the communication fabric.

2. The system of claim 1, wherein the respective bandwidth usage targets include corresponding target latency tolerances for RT transactions; and
wherein to determine that the respective bandwidth usage target is not satisfied, the given agent circuit is further configured to:
determine a current latency tolerance based on current activity; and
determine that the current latency tolerance does not satisfy the respective target latency tolerance.

3. The system of claim 2, wherein the given agent circuit is further configured to:
based on the determination that the respective bandwidth usage target is insufficient, capture up-to-date values for the current and target latency tolerances, and a minimum determined value of the current latency tolerance.

4. The system of claim 2, wherein the given agent circuit is further configured to:
based on the determination that the respective bandwidth usage target is insufficient, change the current latency tolerance to a maximum value.

5. The system of claim 1, wherein the given agent circuit is further configured to:
based on the determination that the respective bandwidth usage target is insufficient, capture a current global timestamp value.

6. The system of claim 1, wherein the given agent circuit is further configured to:
based on the determination that the respective bandwidth usage target is insufficient, cease further processing to maintain a current state.

7. The system of claim 1, wherein the given agent circuit is further configured to:
based on the determination that the respective bandwidth usage target is insufficient, assert an interrupt signal.

8. The system of claim 1, wherein the given agent circuit is further configured to:
set a respective sticky bit for ones of the set of captured values;
block additional writes to a given one of the one or more registers while the respective sticky bit is set; and
based on a read access of the given register, reset the respective sticky bit.

9. The system of claim 1, wherein the given agent circuit includes a snapshot buffer circuit, and wherein the snapshot buffer circuit is configured to:
capture a series of values from the one or more registers in the given agent circuit without affecting the state of the one or more registers; and
store the series of values in the snapshot buffer circuit.

10. The system of claim 1, further comprising a debug circuit configured to:
access operational states of the plurality of agent circuits; and
read at least a portion of the set of current values from the given agent circuit.

11. The system of claim 1, wherein the computer system is configured to operate as a single system-on-chip across the one or more co-packaged integrated circuit dies; and
wherein the plurality of agent circuits is distributed across the one or more co-packaged integrated circuit dies.

12. The system of claim 1, wherein the plurality of agent circuits includes one or more of:
a display controller circuit, a camera circuit, an image signal processing circuit, an audio circuit, and a codec circuit.

13. A method comprising:
distributing, by a performance management circuit, respective indications of available bandwidth to ones of a plurality of agent circuits included in a computer system implemented on one or more co-packaged integrated circuit dies;
receiving, by a latency escalation detector circuit coupled to a given agent circuit of the plurality of agent circuits, a respective indication of available bandwidth for the given agent circuit;
based on determining that the respective indication of available bandwidth is insufficient for the given agent circuit, asserting, by the latency escalation detector circuit, a trigger signal; and
based on the asserting of the trigger signal, capturing, by a snapshot circuit, current values from a set of registers in the given agent circuit without affecting a state of the set of registers.

14. The method of claim 13, wherein determining that the respective indication of available bandwidth is insufficient includes:
determining, by the latency escalation detector circuit, a current latency tolerance based on current activity the given agent circuit; and
determining, by the latency escalation detector circuit, that the current latency tolerance for the given agent circuit is insufficient to satisfy a target latency tolerance.

15. The method of claim 14, further comprising capturing, based on determining that the current latency tolerance is insufficient, up-to-date values for the current and target latency tolerances, and a minimum determined value of the current latency tolerance.

16. The method of claim 13, further comprising reducing, by the given agent circuit in response to the asserting of the trigger signal, activity that consumes available bandwidth.

17. An apparatus, comprising:
an agent circuit configured to:
receive an indication of a current available bandwidth for a communication fabric, coupled to the agent circuit, that is configured to support transactions between the agent circuit and other circuit blocks; and
issue real-time (RT) transactions via the communication fabric in accordance with the indication, wherein RT transactions have a higher priority than other types of transactions;
a latency escalation detector circuit that is coupled to the agent circuit and configured to:
receive the indication of the current available bandwidth;
determine that the indicated current available bandwidth is insufficient for tasks assigned to the agent circuit; and
based on the determination that the indicated current available bandwidth is insufficient, assert a trigger signal; and
a snapshot circuit that is coupled to the agent circuit and configured to:
based on the assertion of the trigger signal, capture current values from a particular set of registers in the agent circuit without affecting a state of the particular set of registers.

18. The apparatus of claim 17, wherein the snapshot circuit includes a buffer circuit, and wherein the snapshot circuit is further configured to:
capture, prior to the trigger signal, a series of values from the particular set of registers; and
store the series of values in the buffer circuit.

19. The apparatus of claim 17, further comprising a different snapshot circuit that is coupled to the agent circuit and configured to:
based on the assertion of the trigger signal, capture current values from a different set of registers in the agent circuit without affecting a state of the different set of registers, wherein the particular set and different set are mutually exclusive.

20. The apparatus of claim 19, wherein a number of captured values in the particular set is different than a number of captured values in the different set.
